(19) United States
(12) Patent Application Publication
(10) Pub. No.: US 2022/0155752 A1
(43) Pub. Date: May 19, 2022

(54) SMART MANUFACTURING FRAMEWORK

(71) Applicant: ODICO A/S, Odense (DK)

(72) Inventors: Asbjørn Søndergaard, Odense (DK); Narendrakrishnan Neythalath, Odense (DK); Jens Pedersen, Odense (DK); Andreas Vinter-Hviid, Odense (DK)

(21) Appl. No.: 17/602,001

(22) PCT Filed: Apr. 14, 2020
(86) PCT No.: PCT/EP2020/060492

§ 371 Date: Oct. 7, 2021

(30) Foreign Application Priority Data
Apr. 11, 2019 (EP) 19168682.3

(51) Int. Cl. G05B 19/4097; G05B 19/19

(52) U.S. Cl. CPC G05B 19/4097; G05B 19/19; G05B 2219/35134; G05B 2219/40519; G05B 2219/31372

(57) ABSTRACT

The present disclosure relates to a computer-implemented method for customizing an automated product manufacturing process. It further relates to a robotic manufacturing system for manufacturing a product based on a fabrication model generated by means of the aforementioned computer-implemented method. One embodiment relates to a computer-implemented method for customizing a parametric design and manufacturing process of a physical product, the method comprising the steps of: obtaining a configurable parametric 3D product model representing a template of the physical product; customizing by a user the parametric 3D product model to provide a product instance describing the desired geometry of the physical product; automatically updating a fabrication model based on the parametric 3D product model; and optionally submitting the fabrication model to a manufacturing machine for fabricating the physical product or a mould for the physical product.

### CROSS-REFERENCE TO RELATED APPLICATIONS

This application is the U.S. National Stage of PCT/EP2020/060492 filed Apr. 14, 2020, which claims priority to European Patent Application No. 19168682.3, filed Apr. 11, 2019, the content of both are incorporated herein by reference in their entirety.

### FIELD OF THE INVENTION

The present disclosure relates to a computer-implemented method for customizing an automated product manufacturing process. It further relates to a robotic manufacturing system for manufacturing a product based on a fabrication model generated by means of the aforementioned computer-implemented method.

### BACKGROUND OF THE INVENTION

Despite significant research efforts spanning more than four decades, the use of robotic manufacturing in global construction has to date seen no large-scale industrial adoption. As such, the international construction industry remains one of the world's largest and least digitized sectors. As a result, productivity in construction has remained stagnant, while comparable sectors such as the manufacturing industry has witnessed an approximate doubling of productivity in the same timeframe; a development, which is largely attributed to its higher penetration levels of robotic automation and general digitization. Due to the economic scale and impact of construction activities worldwide, the international society stands to benefit greatly from any potential technological developments that may increase construction productivity.

The overarching technical challenge that has until now prohibited wide-spread adoption of robotic technologies within the construction space is that unlike other large scale industrial production—such as naval, aeronautic or wind turbine manufacturing—every construction project is unique, offering a project specific combination of design, materials, construction methods, and geographic location. Due to this diversity, the techno-economic paradigm that has enabled significant growth in other production domains—mass manufacturing—is inapplicable within the construction space.

The particular factor prohibiting the application of mass manufacturing methods within construction is that the advantage of this paradigm is based on a model, in which significant up-front capital expenditure on establishing automated production workflows is acceptable, because the investment can be recovered through the optimized manufacturing of a large volume of identical product units. If this volume is equal to one, the expenditure for automating the production workflow largely exceeds the market cost of producing the same entity in a manual or non-automated fashion. As this condition is causing the global construction industry to continuously rely on manual labour for execution of construction tasks, the primary workforce populating the sector is a result trained within manual crafts and project management, and therefore not equipped with the technical education to operate advanced technologies, creating a further barrier to adoption of new manufacturing technologies.

The momentum of research and emerging commercialization of robotic construction solutions is gaining significance, though the industry must currently be characterized as nascent. Some attention has been directed towards exploring the adaptability of industrial robotic manipulators in facilitating shape-variant productions, such as component series with uniquely varying profiles or surfaces. However, while parametric or shape-variant capable production systems do increase manufacturing flexibility, they do so only within the scope of a particular process, and so fail to address the systemic variance across the high diversity of uniquely combined construction processes. Thus, current developments until now have not addressed the most fundamental challenge prohibiting wide-spread automation within the construction space, in the form of achieving general purpose manufacturing technologies which is agnostic to a non-bound spectrum of variance in product design, manufacturing process and production system architecture.

### SUMMARY OF THE INVENTION

There is a need for automating non-standard production in the construction industry. As part of this challenge, there is a need for a new and simpler interface for interaction with robotic processes, e.g. an easy-to-use system for implicit robot manufacturing programming. Similarly, a framework for automation that enable rapid reconfiguration and replacement of the entirety of system constituents is needed. Furthermore, there is a need of a framework that is able to digitally model a wide range of construction workflows while the framework itself remains invariant across the different workflows.

The present disclosure uniquely addresses the above-mentioned challenges by offering a novel method of modelling and controlling unique, digital construction manufacturing workflows through partial automation; and expressing the process controls in a high-level form, that allow non-expert users to operate it. The utility hereof is thus to lower the development cost of establishing a new, project unique digital construction workflow to a degree, in which the efficiency gains of utilizing the established workflow exceeds its development and implementation cost even within a single construction process, when compared to manual production. The scope of the invention is thus to enable a general-purpose technology platform for automation of unique construction processes.

Specifically, the present disclosure addresses the above-mentioned issues by presenting a framework for automatically transforming parametric CAD files to graphical tablet apps, which non-expert users can operate. These applications, in turn, allow their users to change the original design variables, inspect the result visually, and finally submit machine instructions to a manufacturing system for physical realization of a bespoke object or a small series of objects.

A first embodiment relates to a computer-implemented method for customizing a parametric design and manufacturing process of a physical product, the method comprising the steps of: obtaining a configurable parametric 3D product model representing a template of the physical product; customizing by a user the parametric 3D product model to provide a product instance describing the desired geometry of the physical product; automatically updating a fabrication model based on the parametric 3D product model; and optionally submitting the fabrication model to a manufacturing machine for fabricating the physical product or a mould for the physical product.

A second embodiment relates to a computer-implemented method for customizing a parametric design and manufacturing process of a physical product, the method comprising the steps of: obtaining a configurable parametric 3D product model representing a template of the physical product; customizing by a user the parametric 3D product model to provide a product instance describing the desired geometry of the physical product; automatically updating a fabrication model based on the parametric 3D product model; and optionally submitting the fabrication model to a manufacturing machine for fabricating the physical product or a mould for the physical product. wherein the steps of the method constitute a directed acyclic graph (DAG).

The presently disclosed approach presents a simple-to-use software application for customizing and reconfiguring a parametric 3D product model, and a method for initiating an automatic manufacturing process using said software application. Because the initial design is based on a parametric product model, the method allows a non-skilled user to effectively and safely operate a manufacturing process of large-scale items, which normally would require advanced domain-specific fabrication knowledge.

The physical product or the mould for the physical product may be manufactured from a workpiece using a subtractive manufacturing process, an additive manufacturing process, a process in which the material is bent, stretched, or compressed, using a pick and place process (e.g. laying bricks, tiles, or wooden planks), using a process, in which the material of the physical product or workpiece is bent, welded, printed, or sprayed—or any combination thereof. The material of the workpiece may be selected from the group of: ceramic, brick, wood, glass, stone, metal, clay, or synthetic polymers (e.g. polystyrene, expanded polystyrene, or extruded polystyrene foam). As an alternative to the workpiece, an empty build volume or a space into which material is additively layered may be provided, e.g. for 3D construction printing.

The subtractive process may for example be performed by abrasive wire cutting, hot wire cutting, hot-blade cutting, milling, sawing, lasering, or clay cutting.

The conventional method for producing advanced formwork, e.g. for concrete components, entails the following:

The formwork supplier receives a 2D drawing of the requested design.

The design is translated into a production drawing by a computer-aided design (CAD) specialist.

The production drawing is used by a computer-aided manufacturing (CAM) specialist to program a machine to manufacture the formwork parts.

The formwork parts are assembled to a mould by a craft specialist (typically a formwork carpenter).

The entire operation typically takes between 1.5-2 working days and relies on at least three specialist competences. The present disclosure allows a non-expert user to perform the above tasks, which would normally require expert knowledge. This is achieved by providing the non-expert user with a customizable product model, through which the user can customize the product model by changing the value of one or more design variables relevant to the model. The product model is preferably only customizable within a pre-defined set of boundaries, such that the user cannot accidentally create a design, which is not realizable by the machine connected to the software. Furthermore, the product model is custom-made to the specific purpose or product to be manufactured, which means that the user is only exposed to design variables that are relevant to the specific task at hand. Accordingly, the method encapsulates the knowledge of robotic manufacturing in a software framework, while at the same time exposing the design variables of a CAD design to a non-expert user in a way that is easy to understand. In other words, the user does not need to be a CAD expert in order to customize the parametric 3D product model, and the user can with ease submit the design and initiate an automated manufacturing process such as a CAM process.

Thus, by using the method disclosed herein, manufacturing processes, such as the above-mentioned conventional method for producing formwork, are greatly simplified since no specialist competences are needed and furthermore the process can be done in significantly less time. Additionally, the method allows for swift reconfiguration of a parametric 3D model without the use of expert-knowledge as explained above.

The present disclosure further relates to a robotic manufacturing system comprising an automated machine, e.g. a robot, and a processing unit comprising a software application (or providing access to a software application) executable on the processing unit and configured for executing the presently disclosed method for customizing a parametric design and manufacturing process of a physical product, such that the automated machine can be instructed to manufacture the physical product based on the fabrication model generated by means of the software application.

In one embodiment, the robotic manufacturing system constitutes a containerized manufacturing unit for manufacturing parts used in construction. The containerized manufacturing unit allows for the robotic manufacturing system to be easily shipped around the world, and brought directly to a construction site or to a manufacturing plant without excessive need for assembly at the site. The robotic manufacturing system may be mounted in a container, such as a standard intermodal container, e.g. a 10 foot container, a 20 foot container or a 40 foot container, or it may be packed into any transportable unit, thus making the robotic manufacturing system mobile. In another embodiment, the robotic manufacturing system is a standalone manufacturing system, which is mobile, e.g. by being packed in a standard intermodal container.

The robotic manufacturing system may be configured to perform a broad range of different manufacturing tasks, e.g. formwork production, reinforcement bending, wood bending, sheet cutting, tile cutting, bricklaying, welding, lasering, printing, etc. The formwork production allows for the creation of complex objects, e.g. concrete elements, such as architectural elements for a structure or building. The automated machine featured in the robotic manufacturing system may be an industrial robot using a robotic cutting or milling technique, such as robotic hot-wire cutting (RHWC), abrasive wire cutting (AWC), robotic hot-blade cutting, robotic milling, or robotic clay cutting.

The disclosed method couples a configurable product model with an implicit fabrication model, both of which are preferably updated through user induced change(s) of the constituent design variables of the product model. Preferably, the fabrication model is updated either concurrently with any changes to the product model or immediately after any changes to the product model. The product model holds a parametric, relational description of the design geometry with a pre-set number of bounded design variables, while the fabrication model preferably parameterizes the corresponding tool path generation for that design under the constraints of the production system. The fabrication model may describe the geometry and/or the targets corresponding to the product designed in the product model, a part of the product designed in the product model, or a mould for moulding the product designed in the product model.

The product model and its configurable design variables are displayed to the user, preferably through a Graphical User Interface (GUI), which is preferably procedurally generated from the product model. The user may optionally customize or reconfigure the product model any number of times, preferably through said GUI. The user-customized product described in the product model may also be referred to herein as a customized product instance. In one embodiment, the user customization is provided within a predefined set of boundary conditions for the product model. This has the advantage that a non-expert user can safely make any design choices without risking that the design cannot be realized, e.g. due to machine constraints. The fabrication model is preferably silently updated in synchronization with changes in the product model design variables, until production execution is initialized. The fabrication model may be updated by inheriting the product instance from the product model. This update may occur automatically along with the user-induced changes to the product model. The user may further choose to view the fabrication model, e.g. in the aforementioned Graphical User Interface (GUI). In one embodiment, the fabrication model is continuously generated and/or updated during customization of the product model.

Upon completion of the product configuration process, the user may initialize the automatic manufacturing of the customized instance of the product by activating the fabrication model through interaction with a GUI or through a switch, using a machining concept and process automation predefined for that particular type of product. Hence, both digital and physical representations can be rapidly reconfigured to suit changing materials and product geometries, while automatically generating the corresponding visualization that enables non-skilled user interaction.

The present disclosure further relates to a computer-implemented method for customizing a construction workflow for fabricating a physical product by means of a manufacturing machine by representing the construction workflow as a plurality of sub-processes in a directed acyclic graph (DAG), such that each sub-process is represented as a node in a graph data structure with edges connecting the nodes, the method comprising the steps of: providing a customizable parametric product model describing the geometry of the physical product through a set of design variables, each design variable comprising a set of boundaries, the product model further comprising a set of functions defining dependencies between the design variables; providing a display unit model defining a graphical user interface for enabling user manipulation of the design variables within the boundaries for customizing the parametric product model; providing a fabrication model for generating a sequence of targets based on the customized parametric product model, providing a planning model for translating the sequence of targets into executable machine instructions by the manufacturing machine; and optionally providing a manufacturing machine for fabricating the physical product or a mould for the physical product, wherein said manufacturing machine is represented as a node in the DAG, wherein the parametric product model, the display unit model, the fabrication model, and the planning model represent nodes connected by edges in the DAG, such that edges between nodes provide a unilateral direction of data transfer between connected nodes. This method may further be suitable for customizing a plurality of different construction workflows, wherein the DAG is invariant across at least two of said construction workflows.

All of the methods and systems disclosed herein can be employed in the above disclosed method for customizing a construction workflow for fabricating a physical product, the method utilizing one or more directed acyclic graphs.

The present disclosure further relates to a system for customizing a construction workflow comprising a non-transitive, computer-readable storage device for storing instructions that, when executed by a processor, performs the presently disclosed method for customizing a construction workflow for fabricating a physical product.

The present disclosure further relates to a mobile device, such as a tablet, laptop or smartphone, comprising a processor and a memory and being adapted to provide customization of a construction workflow for fabricating a physical product according to the presently disclosed method. The mobile device may be further adapted to provide customization of a parametric design and manufacturing process of a physical product according to the method disclosed herein.

The present disclosure further relates to a computer program having instructions thereon which when executed by a computing device or system causes the computing device or system to provide customization of a construction workflow for fabricating a physical product according to the presently disclosed method.

The present disclosure further relates to a computer program having instructions thereon which, when executed by a computing device or system, causes the computing device or system to provide customization of a parametric design and manufacturing process of a physical product according to the presently disclosed method.

The present disclosure further relates to a computer program having instructions thereon which, when executed by a computing device or system, causes the computing device or system to provide executable machine instructions to a manufacturing machine for fabricating the physical product or a mould for the physical product according to the presently disclosed method.

The present disclosure further relates to a computer-implemented data structure stored in a memory device, the data structure representing a customizable workflow for fabricating a physical product using a manufacturing system, the data structure comprising: a first node representing a customizable parametric product model describing the geometry of the physical product through a set of design variables, each design variable comprising a set of boundaries, the product model further comprising a set of functions defining dependencies between the design variables; a second node representing a graphical user interface enabling a user to customize the product model by changing the value of one or more of the design variables, thereby obtaining a customized product instance; a third node representing a fabrication model derived from said product model, the fabrication model comprising a sequence of targets; a fourth node representing a planning model configured for translating said targets into machine instructions executable by the manufacturing system; optionally a fifth node representing a communication model configured for transmitting the machine instructions to the manufacturing system; and optionally a sixth node representing the manufacturing system configured for receiving the machine instructions for fabricating the physical product, wherein the nodes are connected by edges to form a directed acyclic graph (DAG) representing the entire workflow, wherein the edges enables data transfer from at least one node to at least another node.

All of the methods and systems disclosed herein can be employed in the above disclosed data structure representing a customizable workflow for fabricating a physical product using a manufacturing system, e.g. the presently disclosed manufacturing system.

### BRIEF DESCRIPTION OF THE DRAWINGS

FIG. 1 displays an embodiment of the present disclosure featuring a containerized robotic manufacturing system suitable for executing the presently disclosed method;

FIG. 2 displays an exemplary workflow of the presently disclosed method. The method is modular as it allows modelling and/or executing a wide range of construction workflows;

FIG. 3 displays a detailed workflow according to an embodiment of the present disclosure;

FIG. 4 displays a high-level overview of a system according to an embodiment of the present disclosure;

FIG. 5a displays a first screenshot of a Graphical User Interface (GUI) according to an embodiment of the present disclosure;

FIG. 5b displays a second screenshot of the GUI, wherein a design parameter menu 540 is visible, which may be activated from icon 531 seen on FIG. 5a;

FIG. 6 is a schematic representation of a robotic manufacturing system according to an embodiment of the present disclosure;

FIG. 7 is a flow diagram of the system according to an embodiment of the present disclosure;

FIG. 8 shows an embodiment the presently disclosed method, wherein the method is represented as a directed acyclic graph (DAG) comprising five main nodes;

FIG. 9 shows a method of auto-generating a Graphical User Interface (GUI) according to the present disclosure; and

FIG. 10 shows a sub-process of the presently disclosed method, wherein the planning model is represented as a directed acyclic graph (DAG).

### DEFINITIONS

The term target refers to a position in space intended for a manufacturing tool or an end-effector to reach during manufacturing of the product. The terms targets and machining targets are used interchangeably.

The terms manufacturing system and production system are used interchangeably.

### DETAILED DESCRIPTION OF THE INVENTION

Typically, the first step of the presently disclosed method is the obtainment of a configurable product model. The product model is preferably a parametric computer-aided design (CAD) model, typically described in a design file.

The design file may be an Extensible Markup Language (XML) file or any other format that stores data in a structure, which is machine-readable and human-readable. The design file may be retrieved from a set of stored models within the system or it may be prepared using commercially available software. In case the design file is prepared using third-party software, the model is typically deconstructed using the presently described method in order to extract the design variables constituting the parametric 3D model. The model is preferably subsequently rebuilt using a set of functions to facilitate customization through said design variables. In case the design file is retrieved from a database within the system, the design file is preferably already compatible with the presently disclosed method, i.e. it allows customization through parametric changes within the presently disclosed framework.

The design file preferably serves as an input to a computer program, wherein the user may optionally specify simple instructions on e.g. the layout or which design variables to expose, etc. Based on these instructions and a set of rules relating to the particular machining process, the program may generate a software application, e.g. a tablet application, for creating the actual machine instructions. Thus, the software application may be tailor-made to suit a specific manufacturing process.

The product model is preferably a parametric 3D model that holds a template of a product described by a set of design variables. A collection of product models may be stored in a database or a memory device. The collection of product models may be provided as a library accessible by the software application described elsewhere. The product may be any imaginable product, which can be designed within the presently disclosed framework. Preferably, the product may be manufactured using a manufacturing machine relevant to the manufacture of the product.

The product is preferably described within the parametric product model as a set of geometric points defined in either a 2D- or a 3D-coordinate system. The product is further described through the association of attributes to these geometric points. Examples of attributes could be the position of the point, a number describing the order of the point in a sequence of points, etc. The product is even further described by defining a relation between these points, such as the start- and endpoint of multiple points in a sequence, the distance between neighbouring points, the specific sequence of the points, among possibly other relations. The definition of the product through the geometric points, attributes and relations are handled by a computer program, which stores the data relevant to the geometry and further allows the customization of said geometry, preferably within a pre-defined set of permissible values.

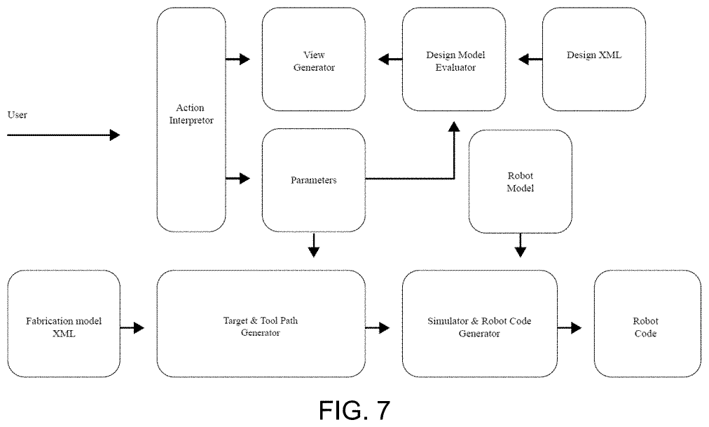

Based on the set of geometric points, a more complex geometry comprising one or more surfaces can be built. An example of a class of surfaces are ruled surfaces, which are a family of Bézier surfaces that has straight lines running across at least in one direction. A ruled surface can be visualized as a set of straight lines running between two curves as depicted in FIG. 7.

Thus, the geometry describing the product may be constructed from a set of geometric points associated with a set of attributes and relations, and on top of these points adding more complex mathematical objects such as curves and surfaces to form a complete three-dimensional geometry. Accordingly, the points, curves and surfaces preferably form a hierarchy defining the parametric model.

Defining the parametric product model in the manner described above allows for the geometry to be changed or manipulated by performing a number of operations or transformations on the set of geometric points, lines, or surfaces. In case the points, lines, and surfaces form a hierarchy, many of said changes can be realised by performing operations on the set of geometric points. An example of an operation could be a spatial transformation of a point, or it could be a change in the curvature of a curve, e.g. by manipulating a control point of a Bézier curve. The curve may have a number of control points suitable for defining the curve. The Bézier curves may be combined to form Bézier surfaces, also featuring control points. An operation can also be the spatial transformation of an entire surface. Thus, the points, lines, and curves may be subject to any transformation such as translation, scaling, homothety, similarity transformation, reflection, rotation, shear mapping, and compositions of them in any combination and sequence.

The entire workflow may internally be represented as a Directed Acyclic Graph (DAG). Hence, the workflow may be represented as a data structure forming a DAG, the data structure comprising a plurality of nodes connected by directed edges, said edges ensuring a unilateral direction of data transfer between connected nodes. Each node comprises at least one input port and at least one output port, wherein each input- and output port preferably is assigned a unique identification number. Furthermore, each node may store and/or execute a function such as an algorithm for geometric or operational processes. Each node may receive at the input port data from a first connected node (i.e. an upstream node), optionally process said data, and transmit via the output port the processed or non-processed data to a second connected node (i.e. a downstream node). The data is transmitted from node to node via the edges connecting said nodes. Hence, the edges enable data transfer in the data structure. Each node may be assigned a unique identification number referring to the entirety of the node, and each node may further be assigned a classification number associated with groups of nodes with identical or nearly identical content. The data structure may further comprise a data storage entity storing a map of the topological connectivity of the graph structure. The map may be provided as a list of connections between individual ports of individual nodes. At least one advantage of representing the workflow as a DAG is that it provides a modular framework with great flexibility, which allows a user to customize a wide-range of construction/manufacturing processes, while the underlying data structure remains invariant.

A feedback loop can be represented in the DAG structure by introducing multiple states of the system and/or the process. As an example, a current state of the system may be denoted as X and a future state of the system may be denoted as X′. A controller node denoted as C may represent all the sensory processing directed at an actuator node. An action performed by the controller or the actuator may bring the system from one state X to another state X′.

The workflow may be described by a DAG at various levels of detail. A node in the DAG may represent a sub-process of the workflow, a part of the manufacturing system, or an operation performed on data passing through the graph structure, depending on the level of detail. At a most generalized level of detail, the workflow may be represented as a DAG comprising a small amount of main nodes, such as 3-6 main nodes, each node representing a sub-process of the workflow. As an example, the workflow may be represented by five main nodes, each node associated with a specific function and/or a specific sub-process of the workflow. The main nodes may each constitute a separate graph structure comprising a plurality of sub-nodes. The main nodes and their internal relationship constitute the principal and minimum data structure required to establish an operational digital entity. The data structure ensures a great variability in product, process and production system configuration while itself remaining invariant. Furthermore, the data structure facilitates a customized end-to-end digital construction manufacturing workflow. The digital workflow may comprise user-customization of a product model, and the generation of executable machine instructions such that a user-customized instance of the product model may be manufactured on a connected production system. The production system may be a cyber-physical production system.

As an example, the workflow is represented as a DAG comprising five nodes, said five nodes comprising a first node representing the customizable parametric product model, a second node representing the display unit model, a third node representing the fabrication model, a fourth node representing a planning model, and a fifth node representing the production system. The product model and the fabrication model are described in more detail elsewhere in the present disclosure. The following description will describe in further detail the other nodes of the workflow.

As another example, the workflow is represented as a DAG comprising four nodes, said four nodes comprising a first node representing the customizable parametric product model, a second node representing the display unit model, a third node representing the fabrication model, and a fourth node representing the planning model.

Optionally, the data structure representing the workflow may further comprise a sixth node, said sixth node representing a communication model facilitating a communication link between the planning model and the production system, such that machine instructions may be transmitted to the production system. Furthermore, the communication model and/or the planning model may receive a system status of the production system.

The fourth node representing the planning model preferably performs a high level planning to adaptively execute the targets provided by the fabrication model for digital producing a customized instance of the product model while monitoring production system status. This is preferably implemented through the steps of: a) transmitting the targets and/or the tool path from the fabrication model to the planning model; b) analysing the validity of the input and checking admissibility of production system status; and c) when admissible, executing production by transmitting machine instructions to the production system, while preferably monitoring the system state of one or more parts of the production system. Preferably, the planning model is configured to react to changes in said system state(s) before, during or after execution with high level planning instructions informed by i) a modular Action Class Library with pre-determined action sets; or ii) a modular Perception Skill Library for high-level analytic functions for interpretation of sensor data. Furthermore, the planning model is preferably configured to evaluate appropriate actions through an Action Identifier, and transmitting decisions through an associated Action Node that control required sectors of the system. The planning model may comprise a low-level motion planner for determining a motion plan and/or a high-level planner for planning, initiating and/or monitoring the manufacturing process.

The high-level planner may be configured to evaluate appropriate actions based on input from a state identifier, said state identifier configured to use one or more functions from a perception skill library. The perception skill library may comprise one or more machine learning algorithms and/or computer vision algorithms, said algorithms being configured to analyse sensor-data related to the specific manufacturing process. The high-level planner may be configured to transmit a correctional action to the manufacturing machine and/or transmit an alert to the user, in case the desired geometry cannot be realised by the manufacturing machine. The high-level planner may further be configured to evaluate whether the targets provided by the fabrication model are admissible. The high-level planner is preferably configured to relay the targets to the low-level motion planner provided the targets are deemed admissible.

The low-level motion planner may be configured to determine a motion plan of a manufacturing tool attached to the manufacturing machine, such that the manufacturing tool follows said motion plan when manufacturing the product, wherein the motion plan is determined based on the targets and/or a virtual representation of the manufacturing machine. The low-level motion planner may receive input relating to the material parameters of a workpiece for manufacturing the product and/or a mould for the product. The low-level motion planner may update the motion plan based on the received input.

The planning model, represented as a main node in the DAG, may itself constitute a DAG. Accordingly, the planning model may constitute a DAG comprising a plurality of nodes, each node representing a sub-process of the manufacturing process. The sub-processes may be selected from the group of: planning the manufacturing process, monitoring the manufacturing process, initiating the manufacturing process, executing the manufacturing process, or combinations thereof. The targets provided by the fabrication model may be transmitted to the planning model, which is preferably configured to translate the targets into machine instructions executable by the manufacturing machine. Accordingly, the planning model is preferably configured to generate machine instructions in a format readable by the manufacturing machine. The planning model may transmit the machine instructions to the manufacturing machine for fabricating the physical product or a mould for the physical product. The high-level planner may be configured to monitor the status of the manufacturing machine. Hence, the planning model may be configured to enquire the status of the manufacturing machine. The high-level planner may be further configured to receive input related to the manufacturing process of the product, said input provided by the manufacturing machine or a sensor monitoring the manufacturing process and/or the manufacturing machine. The target generation performed by the fabrication model may be revised based on the input.

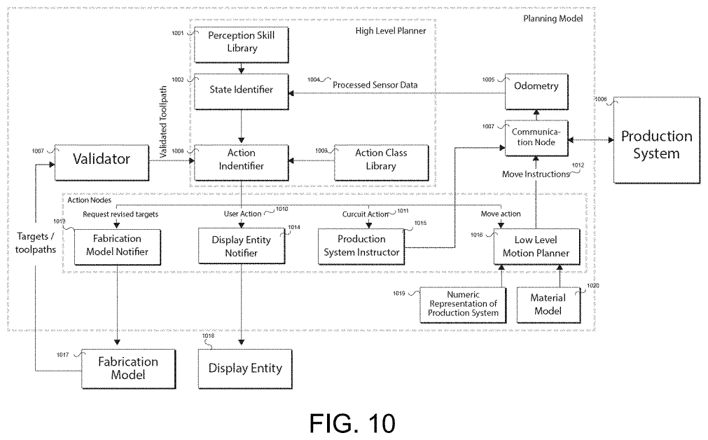

A schematic of the planning model is shown in FIG. 10, and the constituents of the planning model (e.g. the individual sub-nodes and their function) are described elsewhere in the present disclosure.

Representing the product model and/or the fabrication model as a DAG allows encoding the dependency between the various geometric operations in the description of the model. As an example, each node in the product model may perform one or more operations on the data, e.g. a transformation of a point, line, surface, etc. The product model may constitute a DAG comprising a plurality of nodes, wherein at least one of said nodes is configured to apply one or more geometric operations for achieving the desired geometry. Similarly, the fabrication model may constitute a DAG comprising a plurality of nodes, wherein at least one of said nodes is configured to apply one or more operations to the product instance defined by the product model. In general, the initial few nodes in any such model will typically be a group of user input elements, e.g. sliders or text boxes. Hence, such a group forms the entry point to the dependency graph. The data initially composed of the user input will start traversing through the graph structure undergoing transformation as it passes through any of the nodes. Each node preferably receives data from an upstream node; performs a specific operation on the received data altering its content before passing it onto the downstream node. Describing the entire workflow as a Directed Acyclic Graph (DAG) enables a modular replacement of constituents or their interaction workflow, which is preferably paired with a digital representation of the production system, e.g. comprising a modular hardware architecture of a number of manipulators, process end-effectors, a constrained action library and a transportable structural frame. Hence, both digital and physical representation can be rapidly reconfigured to suit changing materials and product geometries, while automatically generating the corresponding visualization that enables non-skilled user interaction.

As explained above, the product model holds a parametric, relational description of the design geometry with a pre-set number of bounded design variables. Accordingly, the geometry of the product may be defined by a set of design variables, wherein each design variable comprises a set of boundaries. The product model may further comprise a set of functions defining dependencies between the design variables. The design geometry described herein is preferably used as an input to generate a fabrication model holding the mechanical and/or manufacturing limitations of the machine or robot intended for the manufacture of the product. Similar to the product model, the fabrication model is preferably also a parametric representation. The fabrication model is preferably used to define the boundary representation (BREP) of the geometry and/or for generating targets based on the product geometry defined in the product model. The fabrication model may be configured to convert a positive shape defining the geometry of the product, to a negative shape defining a mould for the product, or vice versa. Furthermore, the fabrication model may be configured to divide the product instance into a number of parts according to a bounded set of dimensions representing either the dimensions of a workpiece or the reachable workspace of the manufacturing machine. Additionally, the fabrication model may be configured to provide manufacturing related details to the parts, such as interlocks or connections between the parts, or numbering of the parts. The fabrication model may also be configured to apply a pattern of geometric constructs, such as points, lines, curves, surfaces or bounded planes, said geometric constructs describing in part or as a whole the faces of the product instance.

The boundary representation may comprise a set of boundary values describing the limitations of the design due to a number of contributing factors. Example of factors contributing to the boundary representation are the material characteristics of the workpiece (e.g. ceramic, metal, brick, wood, EPS, etc.), the dimensions of the workpiece (e.g. the size of the EPS block, etc.), the design and size of the product to be manufactured, the product geometry, the manufacturing process, the tool definition, and/or the limitations of the machine (e.g. reach, etc.). In the context of brick cutting, the height of each individual brick may constitute an upper boundary. Similarly, there might be a lower boundary related to a minimum thickness of the brick before it breaks too easily. The boundary representation is thus unique both to the specific product to be developed and to the specific machine chosen for the manufacturing process.

The limitations internally described in the fabrication model are in some embodiments further used to divide the product model into two or multiple components, where optimally each component is presented to a user, preferably through a graphical user interface. The parametric product model is preferably further used in combination with the fabrication model to deduct one or more geometric points as targets for the movement of a manipulator often featuring multiple axes, e.g. a 6-axis industrial robot manipulator. The targets are preferably deduced from the boundary representation.

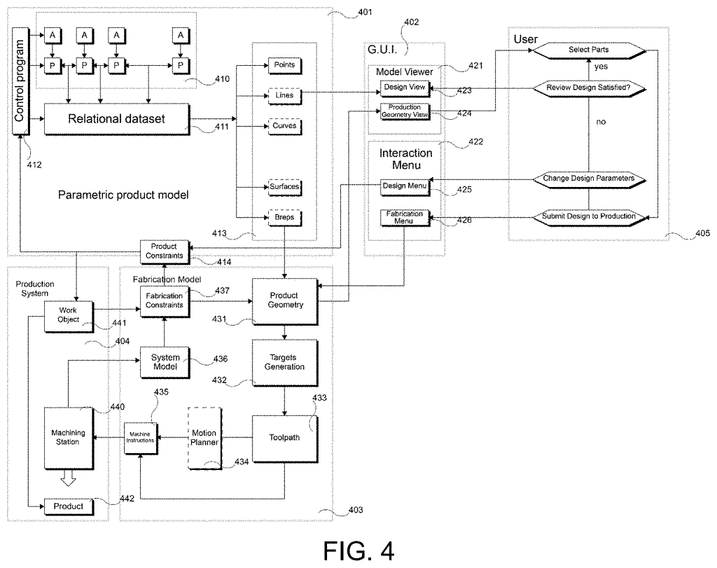

The targets may be used to generate the tool path. The targets may be deduced from boundary representations inside a Target & Tool Path Generator module. Alternatively, the targets may be generated within the fabrication model as shown on FIG. 4. The fabrication model may also be configured to generate a sequence of targets. Furthermore, each target may be assigned one or more attributes such as an orientation specifying the orientation of a manufacturing tool moving through the target. Once the tool path has been computed, it may be passed onto a kinematic solver, which will deduce the motion plan for the manufacturing machine to realize the tool path. Alternatively, the motion plan is computed in a motion planner (e.g. a low-level motion planner) such that the method does not depend on the kinematic solver of the manufacturing system. The above-described step may be followed by a simulation pipeline, which will ascertain the physical realization of the tool path subject to various constraints imposed by the system. During this phase, the generated path is preferably evaluated against collision and out of bounds scenarios. If all these validation routines return success, executable machine instructions for producing the desired geometry is optionally transmitted to a manufacturing machine. The manufacturing machine may be an industrial robot.

Any one of the above-mentioned parametric models, i.e. the product model and/or the fabrication model may be visualized in a graphical user interface (GUI), preferably available to a user through a software application running on an electronic device, e.g. a tablet, a smartphone, a computer, or the like. The GUI may contain functions allowing the user to manipulate/customize the parametric product model or any other parametric model, which is part of the system. Typically, the user is presented with a parametric product model displaying a generic design of the product relevant to the particular application. The product model may be obtained from a database of configurable parametric product models. As an example, the product model may define a model of an architectural element for a structure or a building.

The customization of the model may be done within the GUI through a number of possible operations as described earlier in the application. The operations may be realised through the entry of numerical values, Boolean toggles (e.g. on/off switches), sliders that represent a numeric interval, wheels or turn-buttons that represent a numeric interval, graph-mappers, or editable visualizations of graphs representing any distribution of data-values. The interactions with the GUI may be in the form of finger-gestures; touch-based interactions; voice recognition; a camera recording of a body-pose or a body gesture; or a Brain Computer Interface. The interface may comprise a keypad, a keyboard, a touchscreen, or the like. The GUI may further comprise functions that are available in one or more menus. The GUI may comprise a first menu for design customization, which optionally may hold design variables related to the specific product. The GUI may further comprise a second menu for generic options such as load, save, settings, help, and history. The GUI may further comprise a third menu related to fabrication or process execution, which optionally may hold manufacturing variables related to the manufacturing machine and/or the manufacturing process. A user may preferably also initiate production from the GUI. The contents of the first menu for design customization may change automatically once a new product model is obtained, such that the available design variables are related to the current product model only. Hence, a unique GUI may be automatically generated based on the product model obtained. A user may view and customize the product model using the GUI, e.g. by changing the value of one or more of the design variables. The specific details on how the GUI may be automatically generated are described elsewhere in the present disclosure.

Based on the possible changes by the user, the parametric models are preferably updated, even more preferably they are updated simultaneously in real-time. The GUI may further comprise options for visualising the product model, e.g. the option to automatically divide the product in multiple components, the option to choose a sequence for the production of the individual components, or the adjustment of the manufacturing method used for each individual component. The GUI may further comprise one or more buttons that activate the transmission of any of the parametric models, or part of these, to a machine for initiating the manufacture of the product.

Thus, the presently disclosed method allows a non-expert user to change the geometry of a parametric model, inspect the design visually, and finally submit instructions to a manufacturing system, such as an industrial robot, to manufacture an object featuring a potentially complex geometry.

The entire system is quite versatile and can support a variety of different machining processes and geometries, e.g. for use in the construction industry. Examples of compatible machining processes include Abrasive Wire Cutting (AWC), Hot Wire Cutting (HWC), robotic hot-blade cutting, robotic milling, robotic sawing, welding, lasering, printing, bending, spraying, robotic clay cutting or 3D construction printing. In AWC, frictional force is used to cut out the desired geometry from a cutting element such as a block of expanded polystyrene (EPS). In HWC, a heated wire is used to cut through the cutting element. The machining process could also be water jet or a sawing process for cutting tiles. Another example of a machining process compatible with the present disclosure is a pick and place process, e.g. bricklaying. The system may also be compatible with a machining process capable of producing corner/edge bevelling and/or corner/edge chamfering.

Thus, the present disclosure presents a system and method that allows a user to customize a construction workflow, the method being compatible with a wide-range of machining processes suitable for different purposes such as tile cutting, bricklaying, reinforcement bending, sheet metal working, formwork production, cutting window fillers, bending wood etc.

A particular example of a suitable application of the presently disclosed method is the manufacture of a mould for the creation of complex objects, such as concrete objects, e.g. for realizing advanced building designs in the construction industry. Such a mould can be made from a flexible cutting element, e.g. EPS, which is cut into a desired shape by means of a robotic system. This method is further explained in WO 2017/157917.

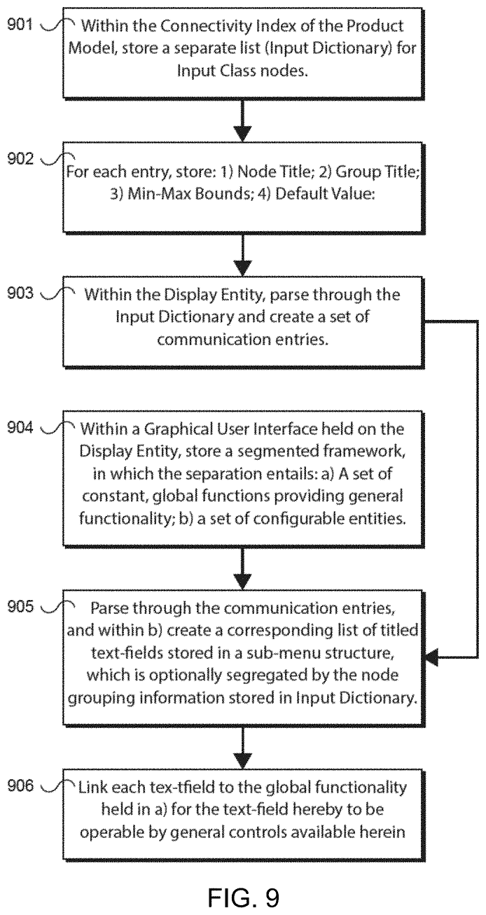

The present disclosure further relates to a method of auto-generating a Graphical User Interface (GUI) as previously explained, such that a unique GUI is obtained depending on the construction workflow modelled or the product model obtained. The GUI preferably exposes the particular controls of the modelled construction workflow, but maintains simplicity by avoiding the inclusion of unrelated, specialist functions. This allows a non-expert user to customize designs of the parametric product model; and execute the customized instance of the design directly on a connected manufacturing system. The method will be described in further detail in the following. An exemplary schematic of the method is shown in FIG. 9. The method preferably comprises the steps of:
creating an Input Group sub-class within a Connectivity Dictionary, said creation pertaining to the node-class comprising root nodes and related nodes that represent design variables within the product model;
storing for each of these entries any of: Node title, Grouping information, Min-max bound sets, Default values, or combinations thereof, establishing within the Display unit model a split framework comprising:
   a. an invariant frame comprising one or more global functions, said function(s) comprising:
   i. a view control menu comprising one or more of the following options: Zoom, Pan, Restore, Rotate, Camera angle selection, Dimension toggles, or combinations thereof;
   ii. a utility menu comprising one or more of the following options: Save, Load, Settings, Help, or combinations thereof; and
   iii. a Task menu comprising one or more of the following options: Undo/redo, Numpad;
   b. a variable frame comprising:
   i. a design menu for manipulation of design variables; and
   ii. a production menu for manipulation of production variables;
building a model-unique parameter and production menu by:
   c. parsing through the product models and/or the product models;
   d. creating one or more entries into the Input Group sub-class;
   e. adding one or more lists of input fields to the design and production menu(s) for each Input Group entry, each text field being connected to the functionalities of the underlying, static frame; and
   f. displaying each node title of the Input Group as a text field title.

The present disclosure further relates to a method of high level planning for configuration-variant production systems. The following description relates to an example of how to facilitate such a method. The method is shown schematically in FIG. 10, which shows the planning model constructed as a DAG with a plurality of sub-nodes, each sub-node having a particular function, which is described in further detail below. The geometric design variability of the product model in combination with the process variability of the potential manufacturing processes for the customized product instances assumes a potential hardware-side customization of the associated production system. As such, to remain feasible, the planning model should preferably be compatible with a non-bound variability of production system configurations in order to enable a final, critical step of executing production on the manufacturing machine. Additionally, to enable safe operations, it is imperative that potential, infeasible user-combinations of design variables does not progress to physical motor action. Finally, to conduct feasible operations, the system should preferably exhibit responsiveness to time-based events, including monitoring of system status; user-initiated interruptions and/or sensor-delivered data on results of the physically executed action. To establish a high-level functionality exhibiting these characteristics, the planning model may be constructed as a DAG, comprising the following sub-node functionalities and relations:

The entirety of the graph is preferably activated upon receiving a sequence of targets or a toolpath from the fabrication model, which passes through a Validator for data consistency validation.

Upon validation completion, validation result and toolpath is preferably passed to an Action Identifier comprising a logic circuit and a protocol for determining action, including execution of production, messaging, abortion or change during execution; revised action after execution. Actions can be routed through the following 4 action nodes:

a. a Display Entity Notifier, which transmits status and related messages to the user via the Graphical User Interface in the display unit model;
b. a Motion Planner, which preferably:
i. reads the toolpath information transmitted from the fabrication model via the Action Identifier;
ii. utilizes a numeric representation of the physical Production System to calculate the feasible motion to and from the start and end of the toolpath; as well as motion required for toolpath execution;
iii. transmit these instructions directly to Control Module of the Production System via the Communication Node; and
iv. in case of infeasibility, publishes a notification to the Action Identifier;
c. a Production System Instructor, which preferably controls non-motion actions on the production system, such as re-activation of circuits, start and stop of motors; and
d. a Fabrication Model Notifier, which preferably publishes calls for toolpath revision to the fabrication model when required;

The Action Identifier relies on a modular Action Class Library, which holds a list of permissible actions and their initiation parameters.

Throughout execution and in passive states, the Action Identifier is preferably notified on system and process status via a node chain comprising:

a. an Odometry Node, which processes internal and external sensor data from the Control Module of the production system, said external sensor data transmitted via
b. a Communication Node, which holds the relevant communication protocol for routing data between all sub-nodes of the Execution Node and the Production System.

The processed sensor data may also be transmitted from the Odometry node to a State Identifier, which compares the sensor data against a modular identifier logic. This identifier logic determines the state of the production system against ongoing action of the planning model and publishes to the Action Identifier. In doing so, it may optionally call high-level analytic functions stored modularly in a Perception Skill Library for advanced sensor data analysis, comprising any of the following: 1) Computer Vision, 2) Machine Learning; 3) Convoluted Neural Network; 4) Deep Learning; 5) Symbolic Logic; or 6) Behavioral Decision Tree functions trained to perform analysis of data streams specific to the modelled workflow.

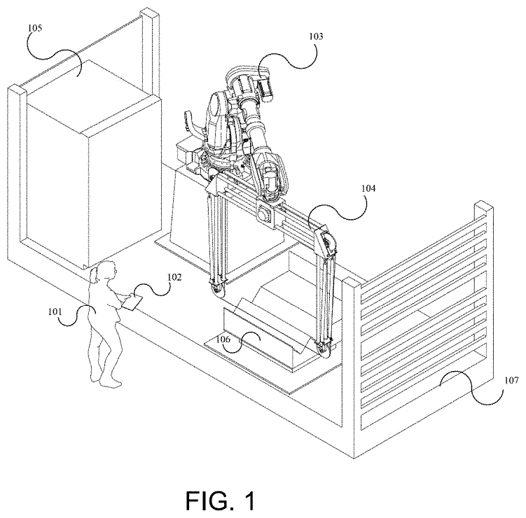

FIG. 1 displays an embodiment of the present disclosure featuring a containerized robotic manufacturing system suitable for executing the presently disclosed method. A non-specialist user 101 is operating a mobile computing device 102 near a robotic manufacturing system 103 entailing a single or multi-axis manipulator holding an end-effector 104 capable of processing through a plurality of means a workpiece consisting of a physical material 106 in order to produce a customized product. The workpiece may be any material suitable for being processed such as: ceramic, brick, wood, glass, stone, metal, clay, or synthetic polymers (e.g. polystyrene, expanded polystyrene, extruded polystyrene foam). Alternatively, the workpiece may be an empty build volume or space into which material is additively layered, e.g. by 3D construction printing. In that case, the material used may be any material suitable for 3D construction printing, e.g. concrete, cement, wax, foam, or polymers. The system is digitally controlled through a server 105, which directs instructions received from the user towards the manipulator. The entirety of the system is controlled by the user through a Graphical User Interface, which enables a customization of selected types of products relative to the specific manufacturing system configuration. A computing device 102, such as a mobile computing device, enables the user to customize a parametric product model to provide a customized product instance representing a physical product. The computing device further allows the user to submit machining instructions to the manufacturing machine for fabricating the physical product or a mould for the physical product in accordance with the presently disclosed method.

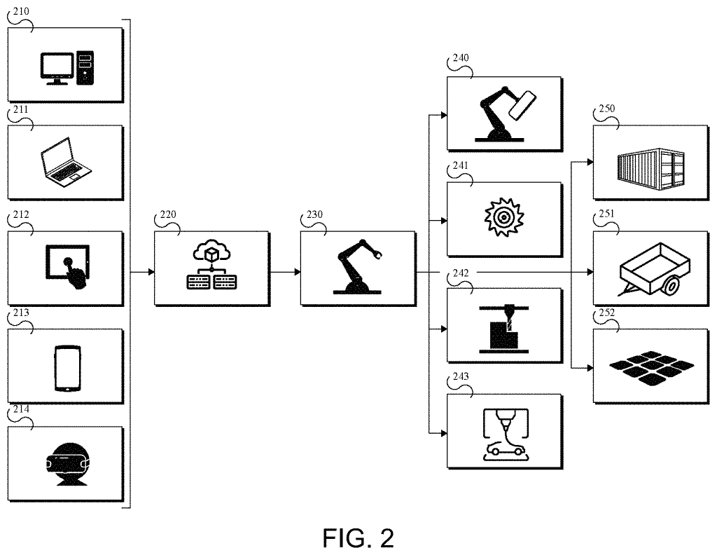

FIG. 2 displays an exemplary workflow of the presently disclosed method. A user may interact with the system through one or more computing and/or actuation devices selected from the group consisting of: stationary computers 210; laptops 211; tablets 212; smart phones 213; head-mounted display devices 214. These devices may transmit user-interactions to the system hosted on a computing platform 220 through means of: typing; hand manipulation; finger gestures; body gestures; voice commands; or eye-gestures. Upon receiving input from one of the computing and/or actuation devices, the method is capable of activating one or more n-axis manipulators 230 holding a plurality of tooling end-effectors, such as wire-cutters 240; saw blades 241; milling spindles 242; material dispensers 243 or any device capable of directing energy towards one or more physical workpieces. These systems may be embodied in structural frames enabling a swift, modular installation or deployment process. Such frames may include transportable, containerized frames 250; mobile trailers 251; stationary platforms 252; or ground mounted systems.

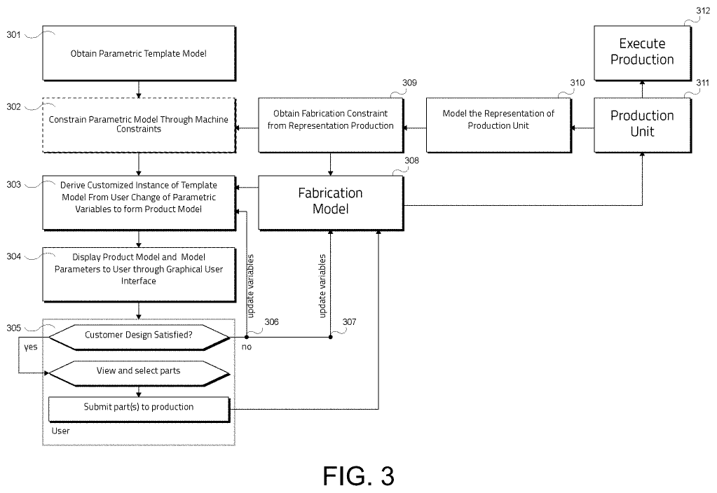

FIG. 3 displays a detailed workflow according to an embodiment of the present disclosure. A parametric template file 301 is obtained from a database of established models or from an external, third-party supplier. Third-party suppliers may be any parametric models created in McNeel Grasshopper, Microstation Generative Components; Autodesk Dynamo, AutoDesk Inventor; Autodesk Revit, Graphisoft ArchiCAD; or any commercial CAD-solution capable of parametric modeling. The product model may be constrained through limiting of the variable intervals to meet production constraints of the intended fabrication method 302. From the product model and optional constraints, a customized instance of the model is derived through user-customization of the constitutive design variables to form a product instance 303. The product model and its constitutive design variables are exposed within a Graphical User Interface as a real-time updated n-dimensional graphical representation and interaction menu for user-manipulation of design variables 304. Through this embodiment, the user can customize the design and instantly review the effect of his interaction in the form of the customized product model. An underlying fabrication model 308 is continuously updated along with the product model. Once the user is satisfied with the customization, a fabrication design resulting from the customized product model can be reviewed by the viewer in the graphical user interface as a selection of one or more parts, which jointly form the final product. The parts can be selected in a desired sequence and submitted to production 305. Submission of parts to production is facilitated by the fabrication model 308, which translate the design geometry of the product model into targets, tool paths and machining instructions through a plurality of geometric and numeric operations. The fabrication model is informed by a fabrication constraint set 309, which is derived itself from a digital model 310 representing the production unit 311. As such, the fabrication model ensures that a valid output is delivered in the form of machining instructions to the production unit 311, which may execute physical production through activation of its mechanical parts to exercise motion or direct energy towards a workpiece located within reachability of the system, hereby executing the production of the customized instance of the original template file.

FIG. 4 displays a high-level overview of a system according to an embodiment of the present disclosure. The system is comprised of 5 main components: the parametric CAD model 401; the Graphical Interface System 402 for interaction with the user of the system 405; the parametric fabrication model 403; and the production system 404. These overall components may be described in their interaction in the following way:

A parametric product model 401 is obtained. The model will be defined by one or more points P₁-Pₙ, which are located within an n-dimensional coordinate system, and to each point attributes A₁-Aₙ may be associated (410). Attributes may constitute position, ID or other attributes. The points are further associated through a relational model 411, which define relations between individual points. Relations may be defined as any instance of sequence, order, lines, curves, surfaces or boundary representations or any operations exerted on these items, such as translation, rotation, transformation or scaling 413. The entirety is controlled through a program 412, which enables the user to manipulate the relations between said points and their derivatives. Said points and any of their derivatives form jointly a parametric representation of any given product, which is n-dimensionally displayed to the user 405 with real-time update of changes through a model viewer 421. Based on the user's perception of the product representation in the model viewer, the individual can perform changes to the representation by manipulation of the interaction menu 422. The interaction menu will submit changes to the variable values controlled by the program 412, in the form of any numerical or Boolean values, hereby conducting a product customization. The product customization may be limited by a set of production constraints 414, which ensure that the user may only input parameter changes that result in a customized instance of the product, which is compatible with the associated production system 404, as well as design related constraints imposed by the author of the parametric CAD-model. The product constraint set may as such be in part informed by the fabrication constraint set 437, which hold a body of constraints related to production. This may include dimensions and material characteristics of the workpiece 441, as well as motion limitation constraints from the machining system model 436.

Once the user is satisfied with the customized instance of the product as displayed in the model viewer 421, design view 423, the individual may review in the same module a production geometry instance 431 of the design. This instance will represent the product as actually produced; specifically the individual parts to which the product is segmented, in order to fit the constraints of the system. Through the GUI interaction menu 422, the user may access a fabrication menu 426 that enables the user to submit parts to production in any desired sequence.

Upon submission to production, machining targets 432 will be derived from the production geometry 431. Machining targets are derivative points which may be attributed a sequence numbering and an orientation to form a tool path 433. Optionally, the tool path may be submitted to a motion planner 434, which may alter the poses of a multiple axes, e.g. a 3-axis manipulator, for target parameters. The motion planner may comprise a high-level planner and a low-level motion planner. Subsequently, or alternatively directly without this step, the tool path is converted to machine instructions 455 through association of movement instructions to the point set comprising the tool path. As such, the machine instructions and/or the tool path may be submitted to the production system 404 which comprise the following: a workpiece 441, which constitute the material piece to be processed into the product 442 by the manufacturing machine 440. The workpiece is a body of material with limited dimensions, compatible with the reach envelope of the manufacturing machine. The material constituting the workpiece may be any material selected from the group of materials characterised by a volumetric thermal expansion coefficient ranging from −60·10⁻⁶K⁻¹ to 1200·10⁻⁶K⁻¹. The workpiece may further represent an empty build volume into which material is additively layered. The manufacturing machine 440 may comprise the following components:

A structural frame supporting the entirety of the system. The frame serves as a modular platform supporting installation of different components relevant to the particular manufacturing process. The frame may be embodied as a containerized frame, a trailer, or a stationary platform.

A server or controller unit, which control 3)

One or more >0-axis manipulators. The manipulator may be any device capable of actuation and translation through movement of one or more axes.

One or more end-effectors, each end-effector mounted on a manipulator, said end-effector being capable of interacting and processing the workpiece though means of subtraction, addition to or forming of the workpiece material through the direction of energy, force, material dispensing or any combination thereof.

Accordingly, the manufacturing machine may be an industrial robot capable of executing a plurality of tasks through interaction with its environment.

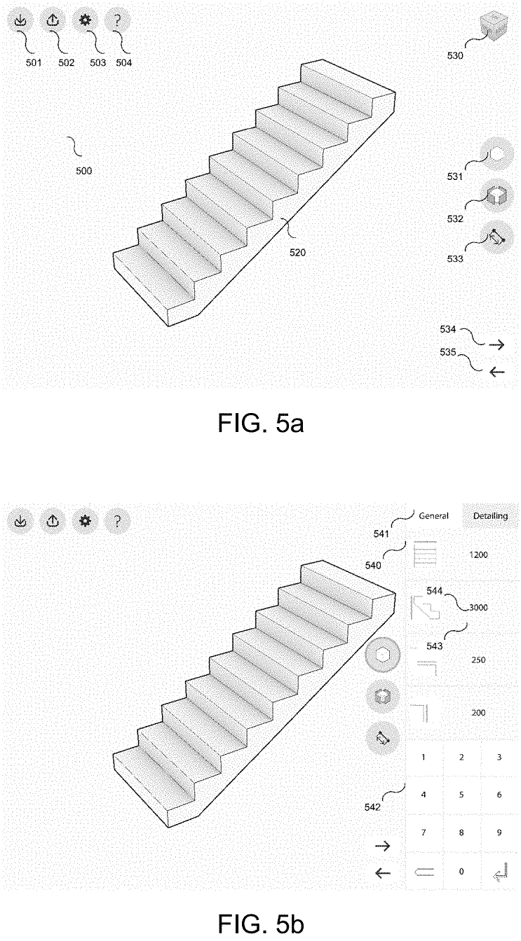

FIG. 5a displays a Graphical User Interface (GUI) according to an embodiment of the present disclosure. The model viewer space 500 allows a plurality of parametric models to be rendered to a user, either pertaining to the view of a design or a production geometry. The rendering may be generated by transmitting a mesh translation of the model to a render node. Within the model viewer space 500, a rendered model 520 may be distinguished from the background through lines or shaded surfaces or any established rendering technique. The interface features a utility menu 501-504, from which files can be loaded or saved; administrative settings may be altered; or help text explaining functions of the interface may be called. The GUI further features a view menu 530, from which a plurality of views may be selected pertaining to the rendering of the main window model. Such views may comprise an orthographic, an isometric or a detailed view of the model or any combination thereof. Through icon 531, a design parameter menu may be accessed, which enables the user to manipulate design variables or other variable values of the model, thereby customizing the design. Through icon 532 a fabrication menu may be called, which enables the user to view a representation of the production geometry of the customized product, including a segmentation of the design into any number of parts from which it may be produced. Such parts may be selected by the user and submitted for fabrication. Through icon 533, a dimensions view may be activated, which renders the dimension sets onto the object. Icons 534-535 enables the user to undo or redo previously exerted actions.

FIG. 5b displays a design parameter menu 540 according to an embodiment of the present disclosure, which may be activated from icon 531 as explained in relation to FIG. 5a. The design parameter menu 540 enables the user through a plurality of means to alter or manipulate the values of the available design variables in order to customize parts of a design to the desired dimensions or configurations. The menu may be comprised of a list of available design variables in the form of individual elements exemplified by icon 543, which are individually accessed. This list may be extended through vertical scrolling or horizontal sideways swiping. Values of a parameter 544 may be edited through a plurality of means, including typing of desired numerical values though a keypad 542.

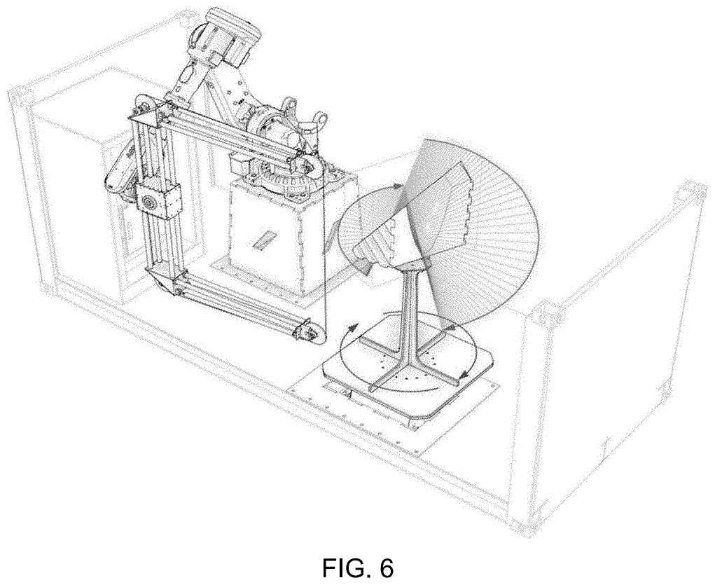

FIG. 6 is a schematic representation of a robotic manufacturing system according to an embodiment of the present disclosure. In this embodiment, the robotic manufacturing system is mounted in a container, i.e. it constitutes a containerized manufacturing unit, which can be easily transported to various construction sites.

FIG. 7 is a flow diagram of the system according to an embodiment of the present disclosure. A design file, in this case in the form of an .XML-file, serves as an input to a Design Model Evaluator. This block extracts the design variables of the parametric model and generates a software application (e.g. a tablet-based application) holding a customizable parametric product model. The product model is rendered and displayed to the user via the View Generator. The user can perform a number of actions via the user interface through the Action Interpretor module. The actions can for instance be related to changing the design variables of the model. These changes are then fed back to the Design Model Evaluator, which in turn updates the model and displays a new version of the model to the user. The user can stay in this loop for as long as he/she likes. The user can also update a fabrication model (e.g. an .XML-file), but this may also be updated automatically in synchronization with updating the product model. The target and Tool Path Generator calculates the tool path of the manufacturing machine, once the user submits the Fabrication Model for fabrication. Based on the tool path, the machine instructions is generated via the Simulator & Robot Code Generator.

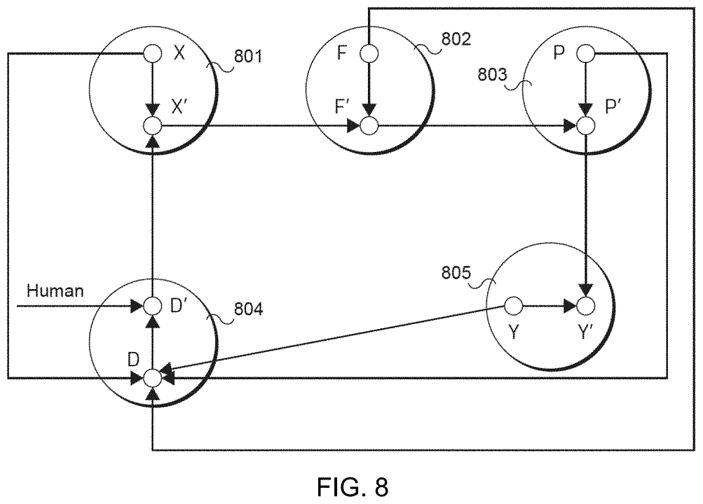

FIG. 8 shows an embodiment the presently disclosed method, wherein the method is represented as a directed acyclic graph (DAG) comprising five main nodes. The five main nodes represent the product model 801, the fabrication model 802, the planning model 803, the display unit model 804, and the production system 805, respectively. The nodes are connected by directed edges that represent data transfer between the nodes. Each of the five main nodes are further internally represented as two nodes, wherein a first node corresponds to an initial state of the model, and a second node (marked by an apostrophe) corresponds to a future state of the model. Thus, an initial state of the product model is denoted X, and a future state of the product model is denoted X′. An initial state of the fabrication model is denoted F, and a future state of the fabrication model is denoted F′. An initial state of the planning model is denoted P, and a future state of the planning model is denoted P′. An initial state of the production system is denoted Y, and a future state of the production system is denoted Y′. An initial state of the display unit model is denoted D, and a future state of the display unit model is denoted D′. A human may interact with the display unit model via a GUI. The display unit model may comprise a model-view-controller (MVC), said model-view-controller preferably configured to enable a user to view a 3D rendering of the product defined by the product model. The 3D rendering of the product may be generated by transmitting a mesh translation of the product to a render node in the display unit model. The product model may be transmitted to the render node such that the GUI displays the product instance immediately after any user-induced changes to the product model. The model-view-controller may be configured to inquire or receive the admissibility status of the targets from the high-level planner. The model-view-controller may be configured to display in the GUI an alert and/or a message to the user based on said status. The model-view-controller may be configured to inquire any changes to the fabrication geometry defined in the fabrication model, and transmit any of said changes to the render node if applicable. Using the GUI, the user may perform changes to the product model, thereby bringing the product model in a new state X′. The change of the product model from the state X to X′ may preferably cause the fabrication model F to be updated to a new state F′ reflecting the changes to the product model. The updated fabrication model F′ may be transmitted to a planning model P′, which may perform a number of planning operations such as determining the motion plan based on a received tool path and/or received targets from the fabrication model. The planning model may preferably be configured to generate machine instructions that may be executed by the production system upon receipt. The machine instructions may be transmitted to the production system, which is indicated by the edge from P′ to Y′. The production system may manufacture the product defined in the product model X′ upon reception of the machine instructions.

FIG. 9 shows a method of auto-generating a Graphical User Interface (GUI) according to the present disclosure. A first sub-process of the method comprises three steps. The first step 901 is to store, within a connectivity index of the product model, a separate list of input class nodes, the separate list constituting an input dictionary. The second step 902 is to store, for each entry, the node title, the group title, min-max bounds, and the default value. The third step 903 is to parse through the input dictionary, within the display unit model, and based hereon create a set of communication entries. A second sub-process of the method preferably comprises the steps of: storing a segmented framework, within the display unit model, in which the separation entails a set of constant, global functions providing general functionality and a set of configurable entities; parsing through the communication entries provided by the first sub-process of the method, and based hereon creating a corresponding list of titled text-fields stored in a sub-menu structure, which is optionally segregated by the node grouping information stored in the input dictionary. The final step 906 of the method of auto-generating the GUI is to link each text-field to the global functionality held in the set of constant global functions, such that the text-field is operable by general controls available herein.

FIG. 10 shows an embodiment of a sub-process of the presently disclosed method, wherein the planning model is represented as a directed acyclic graph (DAG). The individual nodes of the planning model and their functionality is explained elsewhere in the present disclosure along with a method of high level planning.

### EXAMPLES

A high-level overview of an embodiment of the system performing the method is illustrated in FIG. 7. The method starts with a user interacting with the system choosing one of a set of available actions. Examples of possible actions may be “Select”, “Model”, “Orbit”, “Pan”, “Zoom”, “Miscellaneous”, “Admin Operations”, or “Fabricate”, but other actions can form part of the system as well. These actions can be initiated via either gestures or user interface (UI) interactable elements. Any action Aᵢ can only be performed if the system is in an allowable state. The state space on which Aᵢ is deemed valid can be represented by Sᵢ where the constraint Sᵢ≈{ } holds true. For instance, the action “Orbit” possesses a Sᵢ={3D View}. The Action Interpreter accepts the human input, performs the validation and if found valid, propagates it to the relevant sub-system for further processing.

The Design Model Evaluator block depicted in FIG. 7 may be configured to perform several mathematical operations to effectively represent the underlying geometry. Some of these operations include series generation, curve/surface transformations, merge, join, split, curve intersections, offset, fillet etc. The curves and surfaces are preferably represented using Bézier curves and Bézier surfaces, respectively. Boundary representations (BREPs) are a collection of Bézier surfaces. In processes that use a wire to cut the desired geometry out of a cutting element such as a block of EPS, the kind of surfaces that can be manufactured are limited to ruled surfaces. Examples of such processes are AWC and HWC processes.

Bézier surfaces are essentially formed by weaving Bézier curves in two directions, typically denoted U and V. In general, these curves could be of any degree whereas ruled surfaces are a family of Bézier surfaces that has straight lines running across at least in one direction, U or V. Ruled surfaces form an important group in the family of architectural surfaces that we see around us. Though milling is an option for ruled surface creation, AWC and HWC are examples of much faster processes compared to milling. For these two processes the goal is to align the hot/abrasive wire along a straight line in every frame during manufacturing.

A degree n Bézier curve is represented as

C(t)=PMT

where M is a (n+1)×(n+1) matrix defining the coefficients of a Bernstein polynomial, P denotes control points given by (P₀ P₁ . . . Pₙ₋₁ Pₙ), and T is a parameter vector of the form (tⁿ tⁿ⁻¹ . . . t 1)^{T}. It is worthwhile to note that t∈ [0,1]. A Bézier surface of degree (m,n) requires two parameter variables u and v∈ [0,1] and is represented as

x(u,v)=UMPₓNV

y(u,v)=UMP_{y}NV

z(u,v)=UMP_{z}NV

where U is a parameter vector in one direction given by (u^{m} u^{m-1} . . . u 1), M is a (m+1)×(m+1) matrix defining the coefficients of a Bernstein polynomial, N is a (n+1)×(n+1) matrix defining the coefficients of a Bernstein polynomial, and V is a parameter vector in the other direction given by (vⁿ vⁿ⁻¹ . . . v 1)^{T}. Pₓ, P_{y} and P_{z} are x, y and z coordinates of the control points, respectively.

For a ruled surface, n=1 whereas m can take any random positive integer value. As an example, the wire cutting application for the fabrication of formwork for a staircase (see example), m=2 at regions of fillet and in all other places m is set to 1. By setting n=1, we have

$$N = [ \begin{matrix}- 1 & 1 \\ 1 & 0\end{matrix} ]$$

$$V = {( v 1 )}^{T}$$

An easier way of looking at ruled surfaces is to visualize them as a set of straight lines running between two curves. Each surface which belongs to the BREP is constructed from two elementary profile curves. From C(t)=PMT, we can construct the curves C₁(t) and C₂(t). These curves are subdivided into equal number of segments (p). Following this process, a straight line is used to join corresponding set of points from both the curves to produce a set of isocurves I={I₁, I₂, . . . Iₚ₋₁, Iₚ}. An isocurve is a curve of constant u or v on a surface.

Referring to the View Generator in FIG. 7, it converts the parametric representation of polygons into meshes by triangulation for rendering. In a first embodiment, this is achieved by an ear clipping algorithm. A simple polygon can be defined as an ordered sequence of n vertices, namely V₀ through Vₙ₋₁. Any two consecutive vertices are connected by an edge (Vᵢ, Vᵢ₊₁) where 0≤i≤n−2 holds true. Finally, an edge (Vₙ₋₁, V₀) connects the first and last points.

The decomposition of a polygon into triangles is called triangulation of the polygon. From computational geometry, it is known that any triangulation of a simple polygon of n vertices always results in n−2 triangles. In general, various algorithms have been developed for triangulation, each characterized by its asymptotic order. The simplest algorithm, called ear clipping with O(n²), may be used in case n is not huge. Algorithms with better asymptotic order certainly do exist. For example, Constrained Delaunay triangulation (CDT) which has an order of 0(n log n).

The geometric model comprising a set of geometric points and/or curves and/or surfaces that describes the product is preferably further used in combination with the fabrication model to deduct one or more geometric points as targets for the movement of a manipulator preferably featuring multiple axes, e.g. a 6-axis industrial robot manipulator. The targets may be deduced from boundary conditions (BREPs). In the present example, the targets are deduced inside a Target & Tool Path Generator, which is schematically shown in FIG. 7. Each surface that forms the BREP is typically processed sequentially. From the surface, isocurves are deduced as explained before. The midpoint of these isocurves can be computed using either linear interpolation along Iₚ or by substituting (u=constant, v=0.5) in (3) where u∈[0, 1]. The isocurve along with its midpoint forms the target for the end-effector of the machine/robot to reach. Depending on the surface finish requirements, the distance between two consecutive isocurves may be chosen. Subsequent to the identification of all isocurves and their midpoints along the BREP, the tool path is typically calculated. In an embodiment of the present disclosure, an abrasive wire (AWC) is forced to follow the entire set of isocurves to cover the whole collection of surfaces forming the BREP.

Once the tool path has been computed, it may be passed onto a kinematic solver, which will deduce the machine/robot motion to realize the tool path. This step is often followed by a simulation pipeline, which will ascertain the physical realization of the tool path subject to various constraints imposed by the system. During this phase, the generated path may be evaluated against collision and out of bounds scenarios. If all these validation routines return success, machine instructions corresponding to the desired geometry may optionally be transmitted to a robot controller for execution.

An example of a ruled surface is a staircase, whose geometry and design can be realized with the presently disclosed method. According to the presently disclosed method, a first version of a staircase can be created in a parametric computer-aided design (CAD) modeling framework. The output from this CAD modeling framework is a design file, which serves as an input to a computer program. Based on the design file, the computer program extracts the design variables from the parametric model and generates a software application, e.g. a tablet application, which holds a product model. In this example, the product model is a staircase model. The non-expert user is presented with the customizable product model in the software application. The relevant design variables for customizing the staircase could be the overall height/width/depth of the staircase, the height/width/depth of the individual steps of the staircase, or perhaps the curvature of the staircase, among other possible design variables. Thus, the user is only exposed to design variables, which are relevant for customizing a staircase. Furthermore, the user can only customize the staircase within a pre-defined set of boundary conditions, i.e. the user can only create designs that are realizable by the manufacturing machine connected to the software application.

There are multiple ways to build and render a staircase to the user. However, not all these methods will allow the system to expose the design variables to the user for further customization and extract isocurves for robot target generation. To accommodate this need for customization, the geometry (G) is chosen as a n-ary relation of profile polycurves otherwise expressed as G=f(R₁, . . . , Rₛ(t)) where any Rᵢ(t); i∈[1, s] is in turn a n-tuple of generic curves. Alternatively, the expression Rᵢ(t)=(C₁(t), C₂(t), . . . , C_{z-1}(t), C_{z}(t)) is valid. In the degenerate form of G, s=2, hence G_{degenerate}=f(R₁(t), R₂(t)). In such cases, there arises two possibilities, R₂(t) is a mere reflection of R₁(t).

The staircase is an example of such a degenerate reflective geometry. Another possibility is that the structure of R₁(t) and R₂(t) are inherently different, giving rise to a degenerate non-reflective geometry. The advantage of expressing G as a n-ary relation is that it allows generalizing the approach to an entire collection of ruled surfaces where s could take any positive integer value. An example of an algorithm to generate targets, herein exemplified as robot targets, is shown below:

| Algorithm 1 Algorithm to Generate Robot Targets | | |
|---|---|---|
| | 1: | Input: G |
| | 2: | Output: Set of Robot Targets (T ) |
| | 3: | procedure GENERATEROBOTTARGETS |
| | 4: | subdivide ← subdivides polycurves into curves |
| | 5: | segment ← segments a curve (C ) into p segments |
| | 6: | isocurve ← creates an isocurve of degree n |
| | 7: | between 2 points |
| | 8: | i ← o; n ← 1 |
| | 9: | Q ← null |
| | 10: | R ← [R₁(t), ..., Rₛ(t)] |
| | 11: | C ← [C₁(t), ..., C_{z}(t)] |
| | 12: | for i < R.length do |
| | 13: | C ← subdivide(Rᵢ(t)) |
| | 14: | j ← o |
| | 15: | for j < C.length do |
| | 16: | Q_{i,j} ← segment(Cⱼ(t),p) |
| | 17: | j ← j + 1 |
| | 18: | end for |
| | 19: | i ← i + 1 |
| | 20: | end for |
| | 21: | for i < Q.rows do |
| | 22: | for j < Q.columns do |
| | 23 : | I ← isocurve(Q_{i,j,start}, Q_{i + 1,j,start}, 1) |
| | 24: | I_{midpoint} ← interpolate(I ) |
| | 25: | T ← generatetargets(I, I_{midpoint}) |
| | 26: | j ← j + 1 |
| | 27: | end for |
| | 28: | i ← i + 1 |
| | 29: | end for |
| | 30: | end procedure |

Based on the developed system, the capacity of the suggested approach is tested by developing a series of software applications. As an example, the software application is a mobile application suitable for running on a tablet, the mobile application comprising the following functionality a) it comprises the parametric product model of a given product with design variables accessible to customize the product within predefined boundaries; b) it presents in a graphical user interface a fabrication menu, which holds options for the user to select pieces for production c) it allows the user to submit selected pieces for production, whereby the fabrication model parametrically deduct the necessary tool paths and operations within pre-set bounds and transmit that to d) a robotic manufacturing system, said system comprising one or more 6-axis industrial robot manipulators, one or more end-effectors, and a modular structural frame, said manufacturing system being configured to manufacture the customized product.

In this example, a parametric staircase model is developed, which hold the relevant design variables to accommodate most common staircase dimensions and detailing. In other words, the staircase model is represented as a product model. In this example, the product model is loaded in a mobile application running on a tablet, the mobile application comprising a design menu for altering the design variables; and a fabrication menu, which shows the formwork configuration of the customized design, and enables the user to submit formwork parts to fabrication. The interface relevant to this example is shown in FIG. 7. Once submitted, the production code is transmitted to a manufacturing machine, such as an industrial robot holding an AWC end-effector, which cuts the corresponding formwork piece from a standardized EPS material block. The EPS mould is then ready for concrete casting.

By using the above-described method, the conventional process for producing a mould for concrete casting is simplified to involve the following competences: 1) General competence of operating a software application with a complexity level comparable to commonly available mobile applications. 2) The competence to read dimensions from a provided 2D drawing and inputting the corresponding values in the staircase design parameter menu. Both of these tasks can be achieved with the presently disclosed approach with simple and general instructions, which require no specialized training.

The machining time for a formwork of a staircase created out of a bounding box with dimensions 2400×1200×300 mm is less than 7 minutes, which gives a cutting speed of 20 mm/s. This is much faster than a clock time of 1.5-2 working days required for conventional formwork production of a similar item.

An example of a computer-aided design (CAD) modeling framework is Grasshopper by Robert McNeel and associates. Advanced uses of Grasshopper include parametric modelling for structural engineering, and parametric modelling for architecture and fabrication. In the present disclosure, Grasshopper may be used to prepare the design file holding the parametric 3D product model. An example of a cutting element is Expanded Polystyrene (EPS), which is suitable to produce formwork for concrete casting of non-standard structures.

An example of how the system can handle user input, which violates the constraints of the model, is given in the following. A constraint is herein defined by a weight for each parameter and a bound for which the sum of the weighted parameters must be less than or equal. For a model with n parameters and m linear constraints we construct:

The n×m matrix A, where Aᵢⱼ is the jth weight of the ith constraint.

The column vector b where bᵢ is the bound for the ith constraint.

In order to calculate the bounds for the kth parameter, given a fixed assignment of all the other parameters, we do the following:

Let p=(p₁, . . . , pₖ₋₁, pₖ₊₁, . . . , pₙ)^{T} which is a column vector containing all values assigned to the parameters. So one value for each parameter which is not the kth.

Let A′ be A with the kth column removed.

Let c=A′p.

For each i∈[1, 2, . . . , m] (i.e. for each constraint) where Aᵢₖ is different from 0, we get a bound on the kth parameter:

If Aᵢₖ>0 the bound is: pₖ≤(bᵢ-cᵢ)/Aᵢₖ

If Aᵢₖ<0 the bound is: pₖ≥(bᵢ-cᵢ)/Aᵢₖ

Linear/Quadratic programming techniques can be employed to simultaneously adjust all variables in an assignment to make the overall assignment not violate the constraints, while minimizing a cost function.

### Further Details of the Invention

1. A computer-implemented method for customizing a parametric design and manufacturing process of a physical product, the method comprising the steps of:
obtaining a configurable parametric 3D product model representing a template of the physical product;
customizing by a user the parametric 3D product model to provide a product instance describing the desired geometry of the physical product;
automatically updating a fabrication model based on the parametric 3D product model; and
optionally submitting the fabrication model to a manufacturing machine for fabricating the physical product or a mould for the physical product.
wherein the steps of the method constitute a directed acyclic graph (DAG).
   2. The method according to item 1, wherein the product model constitutes a DAG comprising a plurality of nodes, wherein at least one of said nodes is configured to apply one or more geometric operations for achieving the desired geometry.
   3. The method according to any of the preceding items, wherein the fabrication model constitutes a DAG comprising a plurality of nodes, wherein at least one of said nodes is configured to apply one or more operations to the product instance.
   4. The method according to any of the preceding items, wherein the geometry of the product is defined by a set of design variables, each design variable comprising a set of boundaries.
   5. The method according to item 4, wherein the product model comprises a set of functions defining dependencies between the design variables.
   6. The method according to any of the items 4-5, wherein the user may customize the product model by changing the value of one or more of the design variables.
   7. The method according to any of the items 4-6, wherein the design variables are provided in a graphical user interface (GUI).
   8. The method according to any of the preceding items, wherein the fabrication model is updated by inheriting the product instance from the product model.
   9. The method according to item 8, wherein the fabrication model is configured to convert a positive shape defining the geometry of the product, to a negative shape defining a mould for the product, or vice versa.
   10. The method according to any of the items 8-9, wherein the fabrication model is configured to divide the product instance into a number of parts according to a bounded set of dimensions representing either the dimensions of a workpiece or the reachable workspace of the manufacturing machine.
   11. The method according to any of the items 8-10, wherein the fabrication model is configured to provide manufacturing related details to the parts, such as interlocks or connections between the parts, or numbering of the parts.
   12. The method according to any of the items 8-11, wherein the fabrication model is configured to apply a pattern of geometric constructs, such as points, lines, curves, surfaces or bounded planes, said geometric constructs describing in part or as a whole the faces of the product instance.
   13. The method according to any of the preceding items, wherein the fabrication model is configured to generate a sequence of targets.
   14. The method according to item 13, wherein each target is assigned an orientation specifying the orientation of a tool configured to move through the target.
   15. The method according to any of the items 13-14, wherein a planning model is provided, said planning model comprising a low-level motion planner for determining a motion plan.
   16. The method according to item 15, wherein the planning model further comprises a high-level planner for planning, initiating and/or monitoring the manufacturing process.
   17. The method according to any of the items 15-16, wherein the planning model constitutes a DAG comprising a plurality of nodes, each node representing a sub-process of the manufacturing process.
   18. The method according to item 17, wherein said sub-process is selected from the group of: planning the manufacturing process, monitoring the manufacturing process, initiating the manufacturing process, executing the manufacturing process, or combinations thereof.
   19. The method according to any of the items 16-17, wherein the targets are transmitted to the planning model, and wherein the planning model is configured to translate the targets into machine instructions executable by the manufacturing machine.
   20. The method according to item 19, wherein the high-level planner is configured to transmit a correctional action to the manufacturing machine and/or transmits an alert to the user, in case the desired geometry cannot be realised by the manufacturing machine.
   21. The method according to any of the items 19-20, wherein the high-level planner is configured to evaluate whether the targets are admissible.
   22. The method according to any of the items 19-21, wherein the high-level planner is configured to relay the targets and/or the tool path to a low-level motion planner provided the targets are deemed admissible.
   23. The method according to item 22, wherein the low-level motion planner is configured to determine a motion plan of a manufacturing tool attached to the manufacturing machine, such that the manufacturing tool follows said motion plan when manufacturing the product, wherein the motion plan is determined based on the targets and a virtual representation of the manufacturing machine.
   24. The method according to item 23, wherein the low-level motion planner receives input relating to the material parameters of a workpiece for manufacturing the product and/or a mould for the product, and wherein the motion plan is updated based on said input.
   25. The method according to any of the items 19-23, wherein the planning model is configured to generate machine instructions in a format readable by the manufacturing machine.
   26. The method according to item 25, wherein the machine instructions are transmitted to the manufacturing machine for fabricating the physical product or a mould for the physical product.
   27. The method according to any of the items 19-26, wherein the high-level planner is configured to monitor the status of the manufacturing machine.
   28. The method according to any of the items 19-27, wherein the high-level planner is configured to receive input related to the manufacturing process of the product, said input provided by the manufacturing machine or a sensor monitoring the manufacturing process and/or the manufacturing machine.
   29. The method according to item 28, wherein the target generation is revised based on the input.
   30. The method according to any of the items 15-29, wherein the high-level planner is configured to evaluate appropriate actions through an action identifier, and transmitting decisions through an associated action node that controls required sectors of the system.
   31. The method according to any of the items 15-30, wherein the high-level planner is configured to evaluate appropriate actions based on input from a state identifier, said state identifier configured to use one or more functions from a perception skill library.
   32. The method according to any of the items 15-31, wherein the perception skill library comprises one or more machine learning algorithms and/or computer vision algorithms, said algorithms being configured to analyze sensor-data related to the specific manufacturing process.
   item
   33. The method according to any of the preceding items, wherein a display unit model comprising a model-view-controller (MVC) is provided, said model-view-controller configured to enable a user to view a 3D rendering of the product defined by the product model.
   34. The method according to item 33, wherein the 3D rendering of the product is generated by transmitting a mesh translation of the product to a render node.
   35. The method according to any of the items 33-34, wherein the user may view and customize the product model in a graphical user interface (GUI), wherein said customization is performed by changing the value of one or more of the design variables.
   36. The method according to any of the items 33-35, wherein the customized product defined in the product model is transmitted to the render node such that the GUI displays the customized product immediately after any user-induced changes to the product model.
   37. The method according to any of the items 33-36, wherein the GUI comprises at least a first menu and a second menu, the first menu comprising at least the set of design variables relating to the obtained product model; and the second menu comprising a set of generic options such as load, save, settings, help, and history.
   38. The method according to any of the items 33-37, wherein the second menu is updated automatically when a new product model is obtained, such that the second menu only displays the design variables defining the currently obtained product model.
   39. The method according to any of the items 33-38, wherein the GUI comprises a third menu comprising one or more manufacturing variables relating to the manufacturing machine and/or the manufacturing process.
   40. The method according to any of the items 33-38, wherein the model-view-controller is configured to inquire the admissibility status of the targets, said status provided by the high-level planner, and wherein the model-view-controller is configured to display in the GUI an alert and/or a message to the user based on said status.
   41. The method according to any of the items 33-40, wherein the model-view-controller is configured to inquire any changes to the fabrication geometry defined in the fabrication model, and wherein said changes is transmitted to the render node if applicable.
   42. The method according to any of the items 1-41, wherein the physical product or the mould for the physical product is manufactured from a workpiece using a subtractive manufacturing process performed by abrasive wire cutting, hot wire cutting, hot-blade cutting, milling, sawing, lasering, or clay cutting.
   43. The method according to any of the items 1-41, wherein the physical product or the mould for the physical product is manufactured using an additive manufacturing process.
   44. The method according to any of the items 1-41, wherein the physical product or the mould for the physical product is manufactured using a pick and place process and wherein the pick and place process is used to lay bricks, tiles, or wooden planks.
   45. The method according to any of the items 1-44, wherein the set of boundaries comprises at least one limitation selected from the group of: product model dimensions, workpiece dimensions, material characteristics of the physical product, material characteristics of the workpiece, geometry of the physical product, reach of the manufacturing machine, the manufacturing process, or the tool of the manufacturing machine.
   46. A robotic manufacturing system comprising:
an automated machine, e.g. a robot, and;
a processing unit comprising a software application executable on the processing unit and configured for executing the method according to any of the preceding items 1-45, such that the manufacturing machine can be instructed to manufacture the product, or a mould thereof, based on the fabrication model generated by means of the software application.
   47. The robotic system according to item 46, wherein the system is suitable for manufacturing a mould/formwork for the creation of complex objects.
   48. The robotic system according to any of the items 46-47, wherein the robotic system is mobile and the automated machine is a containerized manufacturing unit for manufacturing parts used in construction.
   49. The robotic system according to any of the items 46-48, wherein the automated machine is an industrial robot configured for robotic hot-wire cutting (RHWC), robotic hot-blade cutting, robotic milling, robotic sawing, abrasive cutting, robotic clay cutting, lasering, bending, welding, spraying, or printing.
   50. The robotic system according to any of the items 46-49, wherein the robotic system is a mobile and standalone robotic manufacturing system.
   51. The robotic system according to any of the items 46-50, wherein the robotic system is mounted in an intermodal container.
   52. A computer-implemented method for customizing a construction workflow for fabricating a physical product by means of a manufacturing machine by representing the construction workflow as a plurality of sub-processes in a directed acyclic graph (DAG), such that each sub-process is represented as a node in a graph data structure with edges connecting the nodes, the method comprising the steps of:
providing a customizable parametric product model describing the geometry of the physical product through a set of design variables, each design variable comprising a set of boundaries, the product model further comprising a set of functions defining dependencies between the design variables;
providing a display unit model defining a graphical user interface for enabling user manipulation of the design variables within the boundaries for customizing the parametric product model;
providing a fabrication model for generating a sequence of targets based on the customized parametric product model,
providing a planning model for translating the sequence of targets into executable machine instructions by the manufacturing machine; and
optionally providing a manufacturing machine for fabricating the physical product or a mould for the physical product, wherein said manufacturing machine is represented as a node in the DAG,
wherein the parametric product model, the display unit model, the fabrication model, and the planning model represent nodes connected by edges in the DAG, such that edges between nodes provide a unilateral direction of data transfer between connected nodes.
   53. The method according to item 52, wherein the method is suitable for customizing a plurality of different construction workflows, and wherein the DAG is invariant across at least two of said construction workflows.
   54. The method according to any of the items 52-53, wherein the planning model is configured to transmit the machine instructions to the manufacturing machine for fabricating the physical product or a mould for the physical product.
   55. The method according to any of the items 52-54, wherein the planning model is configured to enquire the status of the manufacturing machine.
   56. The method according to item 52, further comprising the steps of any of the items 2-45.
   57. A computer program having instructions thereon which, when executed by a computing device or system, causes the computing device or system to provide customization of a construction workflow for fabricating a physical product by executing the method according to any of the items 52-55.
   58. A computer program having instructions thereon which, when executed by a computing device or system, causes the computing device or system to execute the method according to any of the items 54-55, thereby providing executable machine instructions to the manufacturing machine for fabricating the physical product or a mould for the physical product.
   59. A computer-implemented data structure stored in a memory device, the data structure representing a customizable workflow for fabricating a physical product using a manufacturing system, the data structure comprising:
a first node representing a customizable parametric product model describing the geometry of the physical product through a set of design variables, each design variable comprising a set of boundaries, the product model further comprising a set of functions defining dependencies between the design variables,
a second node representing a graphical user interface enabling a user to customize the product model by changing the value of one or more of the design variables, thereby obtaining a customized product instance;
a third node representing a fabrication model derived from said product model, the fabrication model comprising a sequence of targets;
a fourth node representing a planning model configured for translating said targets into machine instructions executable by the manufacturing system;
optionally a fifth node representing the manufacturing system configured for receiving the machine instructions for fabricating the physical product; and
optionally a sixth node representing a communication model configured for transmitting the machine instructions to the manufacturing system;
wherein the nodes are connected by edges to form a directed acyclic graph (DAG) representing the entire workflow, wherein the edges enables data transfer from at least one node to at least another node.
   60. The method according to item 59, further comprising the subject matter of any of the items 2-45.
   61. A robotic manufacturing system comprising:
an automated machine;
a processing unit comprising a software application executable on the processing unit and configured for executing the method according to any of the preceding items 1-45, such that the manufacturing machine can be instructed to manufacture the product, or a mould thereof, based on the fabrication model generated by means of the software application.
a memory device storing the data structure according to item 59.

1. A computer-implemented method for customizing a parametric design and manufacturing process of a physical product, the method comprising the steps of:
obtaining a configurable parametric 3D product model representing a template of the physical product;
customizing by a user the parametric 3D product model to provide a product instance describing the desired geometry of the physical product;
automatically updating a fabrication model based on the parametric 3D product model; and
optionally submitting the fabrication model to a manufacturing machine for fabricating the physical product or a mould for the physical product.
wherein the steps of the method constitute a directed acyclic graph (DAG).

2. The method according to claim 1, wherein the product model constitutes a DAG comprising a plurality of nodes, wherein at least one of said nodes is configured to apply one or more geometric operations for achieving the desired geometry.

3. The method according to any of the preceding claims, wherein the fabrication model constitutes a DAG comprising a plurality of nodes, wherein at least one of said nodes is configured to apply one or more operations to the product instance.

4. The method according to any of the preceding claims, wherein the geometry of the product is defined by a set of design variables, each design variable comprising a set of boundaries.

5. The method according to claim 4, wherein the product model comprises a set of functions defining dependencies between the design variables.

6. The method according to any of the claims 4-5, wherein the user may customize the product model by changing the value of one or more of the design variables.

7. The method according to any of the claims 4-6, wherein the design variables are provided in a graphical user interface (GUI).

8. The method according to any of the preceding claims, wherein the fabrication model is updated by inheriting the product instance from the product model.

9. The method according to claim 8, wherein the fabrication model is configured to convert a positive shape defining the geometry of the product, to a negative shape defining a mould for the product, or vice versa.

10. The method according to any of the claims 8-9, wherein the fabrication model is configured to divide the product instance into a number of parts according to a bounded set of dimensions representing either the dimensions of a workpiece or the reachable workspace of the manufacturing machine.

11. The method according to any of the claims 8-10, wherein the fabrication model is configured to provide manufacturing related details to the parts, such as interlocks or connections between the parts, or numbering of the parts.

12. The method according to any of the claims 8-11, wherein the fabrication model is configured to apply a pattern of geometric constructs, such as points, lines, curves, surfaces or bounded planes, said geometric constructs describing in part or as a whole the faces of the product instance.

13. The method according to any of the preceding claims, wherein the fabrication model is configured to generate a sequence of targets.

14. The method according to claim 13, wherein each target is assigned an orientation specifying the orientation of a manufacturing tool configured to move through the target.

15. The method according to any of the claims 13-14, wherein a planning model is provided, said planning model comprising a low-level motion planner for determining a motion plan.

16. The method according to claim 15, wherein the planning model further comprises a high-level planner for planning, initiating and/or monitoring the manufacturing process.

17. The method according to any of the claims 15-16, wherein the planning model constitutes a DAG comprising a plurality of nodes, each node representing a sub-process of the manufacturing process.

18. The method according to claim 17, wherein said sub-process is selected from the group of: planning the manufacturing process, monitoring the manufacturing process, initiating the manufacturing process, executing the manufacturing process, or combinations thereof.

19. The method according to any of the claims 16-17, wherein the targets are transmitted to the planning model, and wherein the planning model is configured to translate the targets into machine instructions executable by the manufacturing machine.

20. The method according to claim 19, wherein the high-level planner is configured to transmit a correctional action to the manufacturing machine and/or transmits an alert to the user, in case the desired geometry cannot be realised by the manufacturing machine.

21. The method according to any of the claims 19-20, wherein the high-level planner is configured to evaluate whether the targets are admissible.

22. The method according to any of the claims 19-21, wherein the high-level planner is configured to relay the targets and/or the tool path to a low-level motion planner provided the targets are deemed admissible.

23. The method according to claim 22, wherein the low-level motion planner is configured to determine a motion plan of a manufacturing tool attached to the manufacturing machine, such that the manufacturing tool follows said motion plan when manufacturing the product, wherein the motion plan is determined based on the targets and a virtual representation of the manufacturing machine.

24. The method according to claim 23, wherein the low-level motion planner receives input relating to the material parameters of a workpiece for manufacturing the product and/or a mould for the product, and wherein the motion plan is updated based on said input.

25. The method according to any of the claims 19-23, wherein the planning model is configured to generate machine instructions in a format readable by the manufacturing machine.

26. The method according to claim 25, wherein the machine instructions are transmitted to the manufacturing machine for fabricating the physical product or a mould for the physical product.

27. The method according to any of the claims 19-26, wherein the high-level planner is configured to monitor the status of the manufacturing machine.

28. The method according to any of the claims 19-27, wherein the high-level planner is configured to receive input related to the manufacturing process of the product, said input provided by the manufacturing machine or a sensor monitoring the manufacturing process and/or the manufacturing machine.

29. The method according to claim 28, wherein the target generation is revised based on the input.

30. The method according to any of the claims 15-29, wherein the high-level planner is configured to evaluate appropriate actions through an action identifier, and transmitting decisions through an associated action node that controls required sectors of the system.

31. The method according to any of the claims 15-30, wherein the high-level planner is configured to evaluate appropriate actions based on input from a state identifier, said state identifier configured to use one or more functions from a perception skill library.

32. The method according to any of the claims 15-31, wherein the perception skill library comprises one or more machine learning algorithms and/or computer vision algorithms, said algorithms being configured to analyze sensor-data related to the specific manufacturing process.

33. The method according to any of the preceding claims, wherein a display unit model comprising a model-view-controller (MVC) is provided, said model-view-controller configured to enable a user to view a 3D rendering of the product defined by the product model.

34. The method according to claim 33, wherein the 3D rendering of the product is generated by transmitting a mesh translation of the product to a render node.

35. The method according to any of the claims 33-34, wherein the user may view and customize the product model in a graphical user interface (GUI), wherein said customization is performed by changing the value of one or more of the design variables.

36. The method according to any of the claims 33-35, wherein the customized product defined in the product model is transmitted to the render node such that the GUI displays the customized product immediately after any user-induced changes to the product model.

37. The method according to any of the claims 33-36, wherein the GUI comprises at least a first menu and a second menu, the first menu comprising at least the set of design variables relating to the obtained product model; and the second menu comprising a set of generic options such as load, save, settings, help, and history.

38. The method according to any of the claims 33-37, wherein the second menu is updated automatically when a new product model is obtained, such that the second menu only displays the design variables defining the currently obtained product model.

39. The method according to any of the claims 33-38, wherein the GUI comprises a third menu comprising one or more manufacturing variables relating to the manufacturing machine and/or the manufacturing process.

40. The method according to any of the claims 33-38, wherein the model-view-controller is configured to inquire the admissibility status of the targets, said status provided by the high-level planner, and wherein the model-view-controller is configured to display in the GUI an alert and/or a message to the user based on said status.

41. The method according to any of the claims 33-40, wherein the model-view-controller is configured to inquire any changes to the fabrication geometry defined in the fabrication model, and wherein said changes is transmitted to the render node if applicable.

42. The method according to any of the claims 1-41, wherein the physical product or the mould for the physical product is manufactured from a workpiece using a subtractive manufacturing process performed by abrasive wire cutting, hot wire cutting, hot-blade cutting, milling, sawing, lasering, or clay cutting.

43. The method according to any of the claims 1-41, wherein the physical product or the mould for the physical product is manufactured using an additive manufacturing process.

44. The method according to any of the claims 1-41, wherein the physical product or the mould for the physical product is manufactured using a pick and place process and wherein the pick and place process is used to lay bricks, tiles, or wooden planks.

45. The method according to any of the claims 1-44, wherein the set of boundaries comprises at least one limitation selected from the group of: product model dimensions, workpiece dimensions, material characteristics of the physical product, material characteristics of the workpiece, geometry of the physical product, reach of the manufacturing machine, the manufacturing process, or the tool of the manufacturing machine.

46. A robotic manufacturing system comprising:
an automated machine, e.g. a robot, and;
a processing unit comprising a software application executable on the processing unit and configured for executing the method according to any of the preceding claims 1-45, such that the manufacturing machine can be instructed to manufacture the product, or a mould thereof, based on the fabrication model generated by means of the software application.

47. The robotic system according to claim 46, wherein the system is suitable for manufacturing a mould/formwork for the creation of complex objects.

48. The robotic system according to any of the claims 46-47, wherein the robotic system is mobile and the automated machine is a containerized manufacturing unit for manufacturing parts used in construction.

49. The robotic system according to any of the claims 46-48, wherein the automated machine is an industrial robot configured for robotic hot-wire cutting (RHWC), robotic hot-blade cutting, robotic milling, robotic sawing, abrasive cutting, robotic clay cutting, lasering, bending, welding, spraying, or printing.

50. The robotic system according to any of the claims 46-49, wherein the robotic system is a mobile and standalone robotic manufacturing system.

51. The robotic system according to any of the claims 46-50, wherein the robotic system is mounted in an intermodal container.

52. A computer-implemented method for customizing a construction workflow for fabricating a physical product by means of a manufacturing machine by representing the construction workflow as a plurality of sub-processes in a directed acyclic graph (DAG), such that each sub-process is represented as a node in a graph data structure with edges connecting the nodes, the method comprising the steps of:
providing a customizable parametric product model describing the geometry of the physical product through a set of design variables, each design variable comprising a set of boundaries, the product model further comprising a set of functions defining dependencies between the design variables;
providing a display unit model defining a graphical user interface for enabling user manipulation of the design variables within the boundaries for customizing the parametric product model;
providing a fabrication model for generating a sequence of targets based on the customized parametric product model;
providing a planning model for translating the sequence of targets into executable machine instructions by the manufacturing machine; and
optionally providing a manufacturing machine for fabricating the physical product or a mould for the physical product, wherein said manufacturing machine is represented as a node in the DAG;
wherein the parametric product model, the display unit model, the fabrication model, and the planning model represent nodes connected by edges in the DAG, such that edges between nodes provide a unilateral direction of data transfer between connected nodes.

53. The method according to claim 52, wherein the method is suitable for customizing a plurality of different construction workflows, and wherein the DAG is invariant across at least two of said construction workflows.

54. The method according to any of the claims 52-53, wherein the planning model is configured to transmit the machine instructions to the manufacturing machine for fabricating the physical product or a mould for the physical product.

55. The method according to any of the claims 52-54, wherein the planning model is configured to enquire the status of the manufacturing machine.

56. The method according to claim 52, further comprising the steps of any of the claims 2-45.

57. A computer program having instructions thereon which, when executed by a computing device or system, causes the computing device or system to provide customization of a construction workflow for fabricating a physical product by executing the method according to any of the claims 52-55.

58. A computer program having instructions thereon which, when executed by a computing device or system, causes the computing device or system to execute the method according to any of the claims 54-55, thereby providing executable machine instructions to the manufacturing machine for fabricating the physical product or a mould for the physical product.

59. A computer-implemented data structure stored in a memory device, the data structure representing a customizable workflow for fabricating a physical product using a manufacturing system, the data structure comprising:
a first node representing a customizable parametric product model describing the geometry of the physical product through a set of design variables, each design variable comprising a set of boundaries, the product model further comprising a set of functions defining dependencies between the design variables,
a second node representing a graphical user interface enabling a user to customize the product model by changing the value of one or more of the design variables, thereby obtaining a customized product instance;
a third node representing a fabrication model derived from said product model, the fabrication model comprising a sequence of targets;
a fourth node representing a planning model configured for translating said targets into machine instructions executable by the manufacturing system;
optionally a fifth node representing the manufacturing system configured for receiving the machine instructions for fabricating the physical product; and
optionally a sixth node representing a communication model configured for transmitting the machine instructions to the manufacturing system;
wherein the nodes are connected by edges to form a directed acyclic graph (DAG) representing the entire workflow, wherein the edges enables data transfer from at least one node to at least another node.

60. A robotic manufacturing system comprising:
an automated machine;
a processing unit comprising a software application executable on the processing unit and configured for executing the method according to any of the preceding claims 1-45, such that the manufacturing machine can be instructed to manufacture the product, or a mould thereof, based on the fabrication model generated by means of the software application.
a memory device storing the data structure according to claim 59.
